(19) United States
(12) Patent Application Publication
(10) Pub. No.: US 2026/0067210 A1
(43) Pub. Date: Mar. 5, 2026

(54) FLEXIBLE EXTENSION STRUCTURE

(71) Applicant: Samsung Electronics Co., Ltd., Gyeonggi-do (KR)

(72) Inventors: Yongsen MA, Milpitas, CA (US); Michail KOUNDOURAKIS, Hamburg (DE); Mark Gorthorn RISON, Cambridge (GB); Srinivas KANDALA, Morgan Hill, CA (US); Ravi GIDVANI, Fremont, CA (US)

(21) Appl. No.: 19/320,804

(22) Filed: Sep. 5, 2025

Related U.S. Application Data
(60) Provisional application No. 63/691,228, filed on Sep. 5, 2024.

(51) Int. Cl. H04L 45/74

(52) U.S. Cl. CPC H04L 45/74

(57) ABSTRACT

Methods and devices of a wireless system are provided. A first STA receives, from a second STA, a frame including an extension indication subfield, a length field or subfield including length data, and an extension context field or subfield including extension context data. The first STA determines that the extension indication subfield indicates an extension. The first STA determines the start and end of the extension context field or subfield within the frame based on the length data. The first STA processes the extension context data.

### CROSS-REFERENCE TO RELATED APPLICATION

This application claims the priority benefit under 35 U.S. C. § 119(e) of U.S. Provisional Application No. 63/691,228, filed on Sep. 5, 2024, the disclosure of which is incorporated by reference in its entirety as if fully set forth herein.

### TECHNICAL FIELD

The disclosure generally relates to wireless systems. More particularly, the subject matter disclosed herein relates to improvements to extending fields to support new and/or optional functions in wireless systems.

### SUMMARY

In wireless systems, new generations of standards may include new functions. The new functions may be needed to support improvements to existing standards. However, existing stations (STAs) may not be configured to support new functions. Furthermore, generations of standards may include optional functions. However, existing STAs may not be configured to support optional functions.

Proposals for consideration by the IEEE Standard (Std) 802.11 Wireless LAN Working Group may include reusing an existing frame/field/element for different purposes. Examples include, but are not limited to, coexistence, power save, non-primary channel access (NPCA), and domain name system (DNS) stateful operations (DSO). A frame/field/element may not have enough reserved bits to indicate new features or additional information. For example, the association identifier (AID) subfield was originally used to identify STAs. In a later generation, AID11 was adapted to support new features such as, for example, announcement frames for beamforming. In an even later generation, AID12 was adapted to support new features such as, for example, resource allocation in an orthogonal frequency-division multiple access (OFDMA) channel. Proposals may include reusing AID12 for different purposes. One issue with these proposals is a frame/field/element may not have the AID12 subfield.

Systems and methods are described herein for a flexible extension structure. The flexible extension structure includes an extension indication which may be utilized in existing fields or in new ultra high reliability (UHR) fields.

The above approaches improve on previous methods because the flexible extension structure may be utilized to support a plurality of functions including optional functions and/or new functions in future 802.11 generations.

In an embodiment, a method is performed by a first STA. The method includes receiving, from a second STA, a frame including: an extension indication subfield, a length field or subfield including length data, and an extension context field or subfield including extension context data. The method includes determining that the extension indication subfield indicates an extension. The method includes determining the start and end of the extension context field or subfield within the frame based on the length data. The method includes processing the extension context data.

In an embodiment, a method is performed by a STA. The method includes generating an extension indication subfield for a frame, the extension indication subfield indicating an extension. The method includes generating an extension context field or subfield including extension context data. The method includes generating a length field or subfield indicating a length of the extension context field or subfield. The method includes appending the extension indication subfield, the extension context field or subfield, and the length field or subfield to the frame. The method includes transmitting the frame to at least one other STA.

### BRIEF DESCRIPTION OF THE DRAWING

In the following section, the aspects of the subject matter disclosed herein will be described with reference to exemplary embodiments illustrated in the figures, in which:

FIGS. 1A-1B are diagrams illustrating 802.11 frame formats with extensible fields, according to various embodiments;

FIG. 2 is a flowchart illustrating a method for receiving and processing an extension indication, according to an embodiment;

FIG. 3 is a flowchart illustrating a method for generating and transmitting a frame with an extension indication, according to an embodiment;

FIG. 4 is a flowchart illustrating a process for receiving and processing an extension indication, according to an embodiment;

FIG. 5 is a flowchart illustrating a process for generating and transmitting a frame with an extension indication, according to an embodiment;

FIGS. 6A-6D are diagrams illustrating various frame formats for communicating an extension indication, according to various embodiments;

FIGS. 7A-7D are diagrams illustrating various frame formats for communicating one or more extension indications, according to various embodiments;

FIGS. 8A-8C are diagrams illustrating various frame formats for communicating multiple extension indications, according to various embodiments;

FIG. 9 is a block diagram of a STA in a network environment, according to an embodiment; and

FIG. 10 shows a system including a first STA and a second STA in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “non-primary,” etc.) may be occasionally interchangeably used with a corresponding non-hyphenated version (e.g., “two dimensional,” “predetermined,” “nonprimary,” etc.), and a capitalized entry (e.g., “Counter Clock,” “Row Select,” “Non-Primary,” etc.) may be interchangeably used with a corresponding non-capitalized version (e.g., “counter clock,” “row select,” “non-primary,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“IEEE”as used herein refers to the Institute of Electrical and Electronics Engineers.

“LAN” as used herein refers to a Local Area Network. A “WLAN” as used herein refers to a Wireless LAN.

“Subfield” as used herein refers to a specific part of a data frame in networking protocols such as, for example, IEEE 802.11. A subfield may contain particular information about a data frame's type, function, and/or control details. In the context of 802.11 frames, subfields may define a protocol version, frame type, and/or subtype, which may be required for proper communication and data handling. In this disclosure, subfield and field are interchangeable.

“Extension indication subfield” as used herein is a specific type of subfield that may indicate that one or more existing fields or subfields may be utilized for new or optional data. The new or optional data may be accepted by a protocol associated with a data frame.

“Length field or subfield” as used herein is a specific type of field or subfield that may comprise length data.

“Length data” as used herein indicates a length of an extension context field or subfield. The length may be expressed in bits, octets, or any other unit of digital information.

“Extension context field or subfield” as used herein is a specific type of field or subfield that may comprise extension context data.

“Extension context data” as used herein contains new or optional data. The new or optional data may be accepted by a protocol associated with a data frame.

An “extension” as used herein indicates the presence of a length field or subfield and an extension context field or subfield.

An “extensible field or subfield” as used herein is a field or subfield with one or more existing or new information bits. Existing or new information bits may be a part of a data frame standard that may be utilized for new or optional features. Existing or new information bits may be utilized as an extension indication subfield.

Some of the principles of this disclosure may relate to formats of a network protocol. This disclosure includes a flexible extension structure which may include one bit in an existing field or in a new ultra-high reliability (UHR) field. The flexible extension structure may be configured for extension indication which may support one or more functions.

Although various embodiment of the present disclosure are described below with reference to IEEE standards and protocols, the present disclosure is not limited thereto. For example, the various embodiment may also be applicable to other types of wireless communication systems, e.g., 3^{rd} generation partnership project (3GPP), long term evolution (LTE), 5^{th} generation (5G) new radio (NR), etc., with some modification.

When a new network feature is introduced, many existing devices (e.g., STAs, mobiles, computing devices) may not be programmed to accept additional information with respect to the new feature. Existing network protocols may include specific frame layouts, fields, and subfields. Some network protocol frames may contain specific fields, subfields, octets, and/or bits that are reserved for future use or optional features. Some network protocol frames may reuse specific fields, subfields, octets, and/or bits that are no longer needed. Some network protocol frames may be modified to support new fields, subfields, octets, and/or bits to support new features and/or additional information.

In an embodiment, an extension indication subfield may comprise 1 bit. The extension indication subfield may be 1 bit of an extensible field. In existing fields or subfields, an existing or new information bit may be reused. In existing fields or subfields, multi-purpose subfield values may be reused. In new fields or subfields, a dedicated bit may be defined for extension indication. The extension indication may have 1 bit to indicate whether a field is extensible or not.

In an embodiment, an extensible field or subfield may comprise a fixed length.

In an embodiment, a length field or subfield may comprise a length based on a length of an extension context field or subfield.

In an embodiment, an extension context field or subfield may comprise a length based on the extension context contained in the extension context field or subfield.

In an embodiment, an existing field may be extended to support multiple functions. For an extension indication, 1 bit in an existing field may be reused. This may be an existing or new information bit or multi-purpose bit. The extension indication may be set to false to disable extension context. The extension indication may be set to false as a default. The extension indication may be set to true to support extended functions. Extension context may include ID/type information to identify different functions. Extension context may also include an extension indication to be extended further in the future if needed. If an existing field has a subfield with variable length that may be matched with a length subfield, an extension context may be appended right after the existing field. Otherwise, the extension context may be appended at the end of header such as, for example, a media access control (MAC) header.

In an embodiment, a new field may be defined to support optional functions and/or new functions in the future. An extension indication may comprise 1 bit, e.g., in 802.11bn fields, for optional and/or future extensions. The extension indication may be set to false for basic 802.11bn functions. The extension indication may be set to true for optional 802.11bn functions and/or new functions for future 802.11 generations. An extension context may be present if optional or post-802.11bn functions are enabled.

In an embodiment, STAs that are programmed to process the extension indication (for example, UHR and post-UHR STAs) may process or ignore the extension context in unicast frames. Unicast frames with extension indication set to 2 may not be sent to legacy STAs unless the legacy STAs are programmed to skip an extension context properly.

In an embodiment, STAs may receive and/or generate and transmit broadcast and/or groupcast frames. For management frames, one or more reserved element IDs may be utilized. A reserved element ID may refer to any unused element ID or any unused element ID extension value. This may enable legacy STAs to skip the Information field of the Element. For control frames, one or more reserved type/subtype/AID values may be utilized. This may enable legacy STAs to skip the information/context associated with the type/subtype/AID. For data frames, one or more reserved control ID values of a control field, e.g., the A-Control subfield, may be utilized. This may enable legacy STAs to skip the control information of the A-Control subfield.

In an embodiment, a length subfield and/or an extension context subfield may be located within a dedicated part of a frame. For example, the end of a MAC header may comprise a dedicated part. The dedicated part may comprise a list of length and/or extension context fields or subfields. The list may follow the same order as the extensible fields.

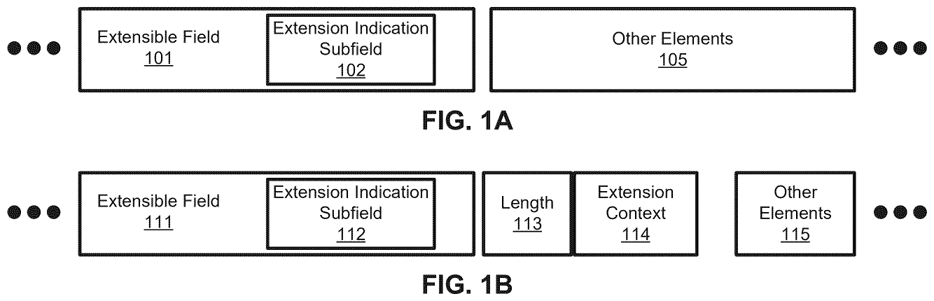

FIGS. 1A-1B are diagrams illustrating 802.11 frame formats with extensible fields, according to various embodiments.

Referring to FIG. 1A, a frame, e.g., an 802.11 frame, may comprise, for example, a Reconfiguration Multi-Link element. The Reconfiguration Multi-Link element may be utilized to announce multi-link (ML) reconfiguration operations by a multi-link device (MLD). The Reconfiguration Multi-Link element may be utilized to support UHR operations to enable, disable, and/or update features. The Reconfiguration Multi-Link element may be configured as an extensible field 101. The extensible field 101 may include an extension indication subfield 102. The extension indication subfield 102 may be contained within the extensible field 101. The extension indication subfield 102 may be configured to indicate no extension. The frame may comprise other elements 105.

Referring to FIG. 1B, a frame, e.g., an 802.11 frame, may comprise, for example, a Reconfiguration Multi-Link element. The Reconfiguration Multi-Link element may be configured as an extensible field 111. The extensible field 111 may include an extension indication subfield 112. The extension indication subfield 112 may be contained within the extensible field 111. The extension indication subfield 102 may be configured to indicate the presence of a length field or subfield 113 and an extension context field or subfield 114. For example, in 802.11, the extension context field or subfield 114 may comprise UHR features. The frame may comprise other elements 115.

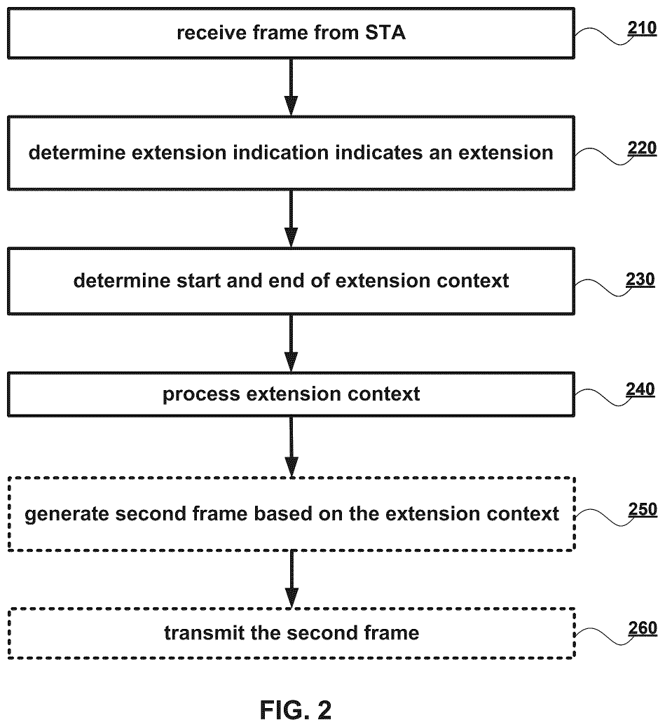

FIG. 2 is a flowchart illustrating a method for receiving and processing an extension indication, according to an embodiment.

Referring to FIG. 2, at 210, a first STA (e.g., 901, 1005) may receive a frame, e.g., an 802.11 frame, from a second STA (e.g., 902, 904, 908, 1010). The first STA may be an access point (AP) or a non-access point STA. The second STA may be an AP or a non-access point STA. The frame may include an extension indication subfield (e.g., 602, 622, 632, 702, 712, 716, 722, 726, 732, 736, 740, 802, 806, 812, 816, 822, 826). The extension indication subfield may comprise a single bit. The extension indication subfield may comprise a plurality of bits, with one of the bits indicating an extension. The frame may include a length field or subfield (e.g., 603, 623, 633, 703, 713, 717, 723, 727, 733, 737, 741, 803, 807, 813, 817, 823, 827) including length data. The frame may include an extension context field or subfield (e.g., 604, 624, 634, 704, 714, 718, 724, 728, 734, 738, 742, 804, 808, 814, 818, 824, 828) including extension context data. At 220, the first STA may determine that the extension indication subfield indicates an extension. For example, if the extension indication subfield is set to true, the extension indication subfield may indicate an extension. For example, if the extension indication subfield is set to false, the extension indication subfield may indicate no extension.

At 230, the first STA may determine the start and the end of the extension context field or subfield based on the length data. A start and end of a field may be based on number of bits, octets, or any other unit of digital information in the frame. At 240, the first STA may process the extension context data. The first STA may be specifically programmed to follow a specific specification. The first STA may be specifically programmed to follow specific rules in a specific standard. At 250, the first STA may generate a second frame, e.g., a second 802.11 frame, including a payload based on the extension context data. The payload may comprise data based on the extension context data. Alternatively, the first STA may take other actions based on the extension context data. At 260, the first STA may transmit the second frame to the second STA.

In an embodiment, an 802.11 frame may comprise a multicast management frame. An extension indication subfield may be part of an existing or new information element.

In an embodiment, an 802.11 frame may comprise a multicast control frame. An extension indication subfield may be part of an existing or new field.

In an embodiment, an 802.11 frame may comprise a multicast data frame. An extension indication subfield may be part of a control subfield using at least one reserved value. For example, an 802.11 frame may comprise a frame control field. The frame control field may comprise control subfields. The control subfields may be utilized to designate a protocol version, type, and subtype. In this example, the type may comprise one of management, control, and data. In this example, the subtype may provide further classification within a given type. Reserved values are designated within a specific standard.

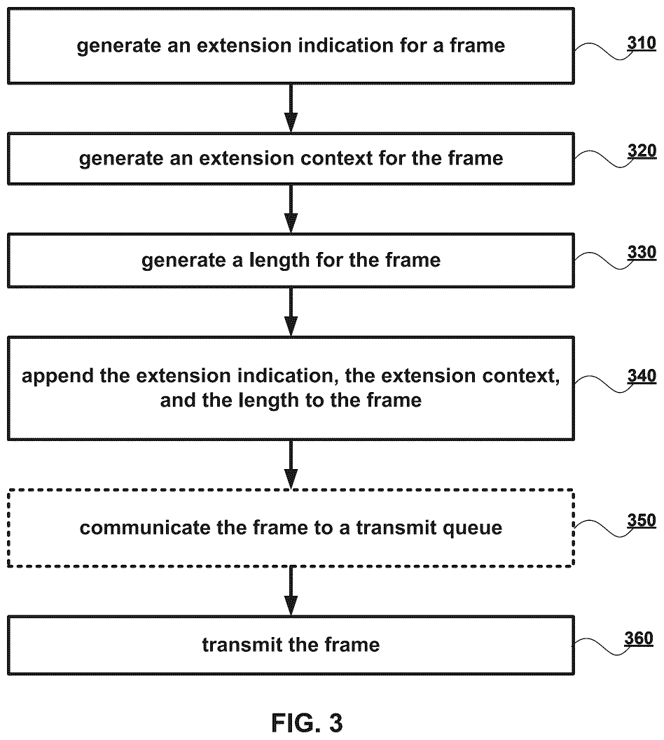

FIG. 3 is a flowchart illustrating a method for generating and transmitting a frame with an extension indication, according to an embodiment.

Referring to FIG. 3, at 310, a STA (e.g., 901, 1005) may generate an extension indication subfield (e.g., 602, 622, 632, 702, 712, 716, 722, 726, 732, 736, 740) for a frame, e.g., an 802.11 frame. The extension indication subfield may have a single bit indicating an extension. At 320, the STA may generate an extension context field or subfield (e.g., 604, 624, 634, 704, 714, 718, 724, 728, 734, 738, 742, 804, 808, 814, 818, 824, 828). The extension context field or subfield may include extension context data. At 330, the STA may generate a length field or subfield (e.g., 603, 623, 633, 703, 713, 717, 723, 727, 733, 737, 741, 803, 802, 813, 817, 823, 827). The length field or subfield may indicate a length of the extension context field or subfield. At 340, the STA may append the extension indication subfield, the extension context field or subfield, and the length field or subfield to the frame. At 350, the STA may communicate the frame to a transmit queue for transmission. At 360, the STA may transmit the frame to at least one other STA (e.g., 902, 904, 908, 1010).

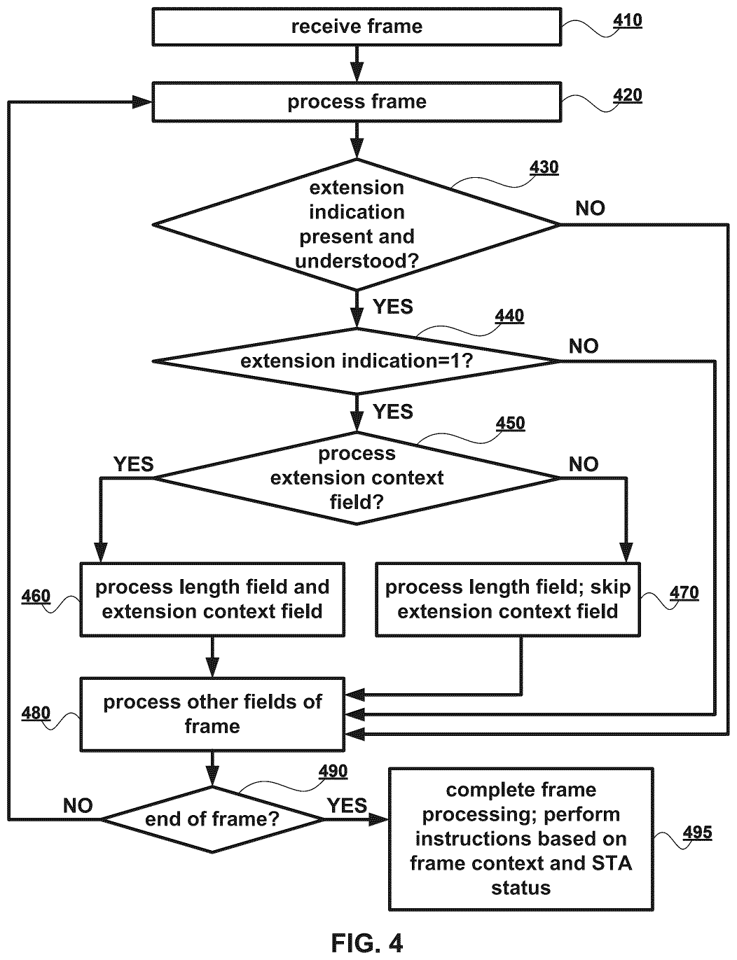

FIG. 4 is a flowchart illustrating a process for receiving and processing an extension indication, according to an embodiment.

Referring to FIG. 4, at 410, a STA (e.g., 901, 1005) may receive a frame, e.g., an 802.11 frame. At 420, the STA may process the 802.11 frame. At 430, the STA may determine if an extension indication is present in the 802.11 frame and if the extension indication is understood. At 440, the STA may determine if the extension indication equals 1 (or true). At 450, the STA may determine if an extension context field or subfield (e.g., 604, 624, 634, 704, 714, 718, 724, 728, 734, 738, 742, 804, 808, 814, 818, 824, 828) may be processed. At 460, the STA may process a length field or subfield (e.g., 603, 623, 633, 703, 713, 717, 723, 727, 733, 737, 741, 803, 807, 813, 817, 823, 827) and the extension context field or subfield. At 470, the STA may process the length field or subfield and skip the extension context field or subfield. At 480, the STA may process other fields in the frame. At 490, the STA may determine if the end of the frame has been reached. At 495, the STA may complete frame processing and perform instructions based on the frame context and the status of the STA. The extension indication may be embedded in an extension indication subfield (e.g., 602, 622, 632, 702, 712, 716, 722, 726, 732, 736, 740, 802, 806, 812, 816, 822, 826).

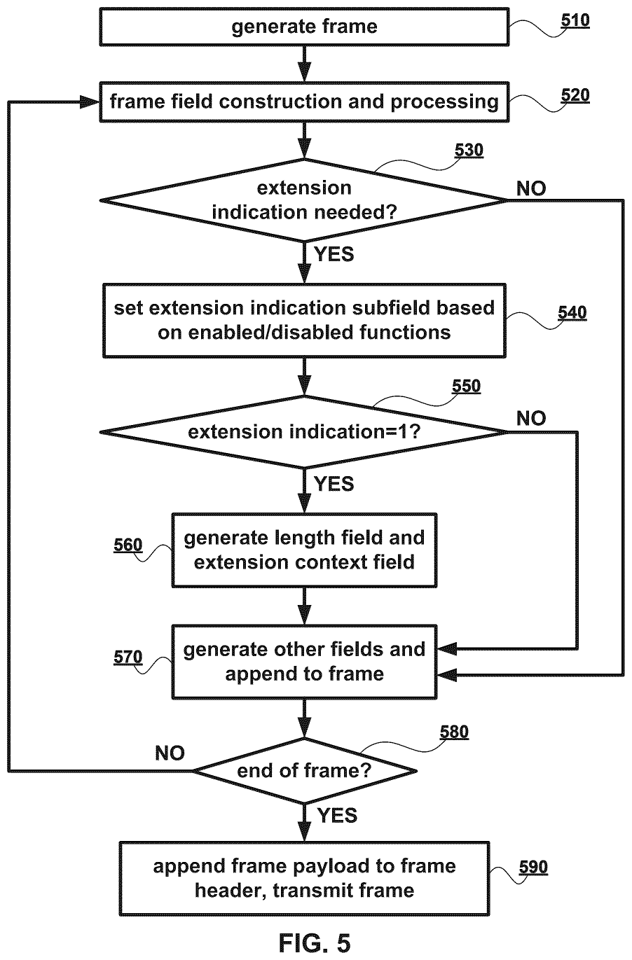

FIG. 5 is a flowchart illustrating a process for generating and transmitting a frame with an extension indication, according to an embodiment.

Referring to FIG. 5, at 510, a STA (e.g., 901, 1005) may generate a frame, e.g., an 802.11 frame. At 520, the STA may perform field construction and processing. At 530, the STA may determine if an extension may be needed. At 540, the STA may set an extension indication subfield (e.g., 602, 622, 632, 702, 712, 716, 722, 726, 732, 736, 740, 802, 806, 812, 816, 822, 826) based on enabled and/or disabled functions. At 550, the STA may determine if the extension indication is set to 1 (or true). At 560, the STA may generate a length field or subfield (e.g., 603, 623, 633, 703, 713, 717, 723, 727, 733, 737, 741, 803, 807, 813, 817, 823, 827) and an extension context field or subfield (e.g., 604, 624, 634, 704, 714, 718, 724, 728, 734, 738, 742, 804, 808, 814, 818, 824, 828). At 570, the STA may generate other fields and append the other fields to the frame. At 580, the STA may determine if the end of the frame has been reached. At 590, the STA may append a frame payload to a frame header and transmit the frame. The frame may be transmitted to another STA (e.g., 902, 904, 908, 1010).

2FIGS. 6A-5D are diagrams illustrating various frame formats for communicating an extension indication, according to various embodiments.

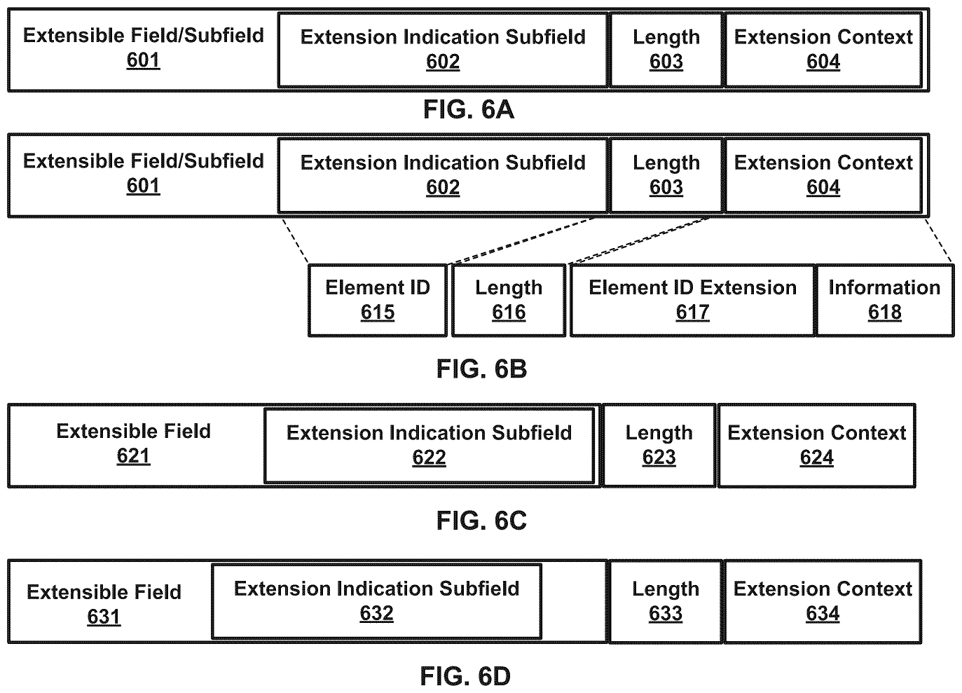

Referring to FIG. 6A, a frame e.g., an 802.11 frame, may include an extensible field or subfield 601. The 802.11 frame may include an extension indication subfield 602. The extension indication subfield 602 may be contained within the extensible field or subfield 601. The extension indication subfield 602 may be configured to indicate the presence of a length subfield 603 and an extension context subfield 604. The length subfield 603 and the extension context subfield 604 may be contained within the extensible field or subfield 601. When an extension indication in the extension indication subfield 602 is 0 (or false), the length subfield 603 and the extension context subfield 604 are not present. When the extension indication in the extension indication subfield 602 is 1 (or true), STAs that are not programmed to process an extension context contained in the extension context subfield 604 may skip the extension context subfield 604 by processing the length subfield 603. STAs that are programmed to process the extension context may process the extension context subfield 604 by processing the length subfield 603, and take actions accordingly. For example, actions may include but are not limited to sending a response frame, adjusting operating modes or parameters, and/or switching to a different bandwidth or channel. The length subfield 603 may indicate the number of octets in the extension context subfield 604. The 802.11 frame may be configured to support one or more functions of 802.11bn and/or one or more new functions in future generations of 802.11.

In an embodiment, an 802.11 frame including a reconfiguration multi-link element may be extended by utilizing an extension indication subfield, a length field or subfield, and an extension context field or subfield.

Referring to FIG. 6B, the extension indication subfield 602 may relate to an information element comprising an element ID 615. The element ID 615 may be configured to provide an identifier of the information element. The length subfield 603 may relate to an information element comprising a length 616. The extension context subfield 604 may relate to a combination of information elements. For example, a combination of information elements may comprise an element ID extension 617 and information 618. The element ID extension 617 may be configured to provide an identifier of the information element. The information 618 may comprise data intended for a receiving STA.

The embodiment illustrated in FIG. 6B is not limited to management frames. The embodiment may be used for any field or subfield of a MAC header of any frame. The embodiment may also work for certain physical layer protocol data unit (PPDU) fields in a physical layer (PHY) header. For example, if a certain PPDU field has no difference between two generations, the extension indication is 0. Otherwise, the extension indication is 1, followed by the extension context for the new generation. This may comprise a simple change with low overhead (as low as 1 bit). Use of a specific field or subfield that is to be extended may be more efficient and effective for legacy STAs, UHR STAs, and future generation STAs.

Element ID may not be needed. There may be no need to occupy the element ID or element ID extension context. If extension indication is 1, the extension context may be ignored by certain STAs that are not programmed to process the extension context or do not need the extension context. There may be no need to follow the relative order, check the capability for the presence of each element, or try to match the element ID to process each element.

Referring to FIG. 6C, an extension indication subfield 622 may be located at the end of an extensible field 621. The extension indication subfield 622 may be followed by length field or subfield 623. The length field or subfield 623 may be followed by extension context field or subfield 624.

Referring to FIG. 6D, an extension indication subfield 632 may be located in between the beginning of an extensible field 631 and the end of the extensible field 631. The extension indication subfield 632 may be located anywhere in the extensible field 631 that is unused/reserved/multi-purpose. The extension indication subfield 632 may be followed by a length field or subfield 633. The length field or subfield 633 may be followed by an extension context field or subfield 634.

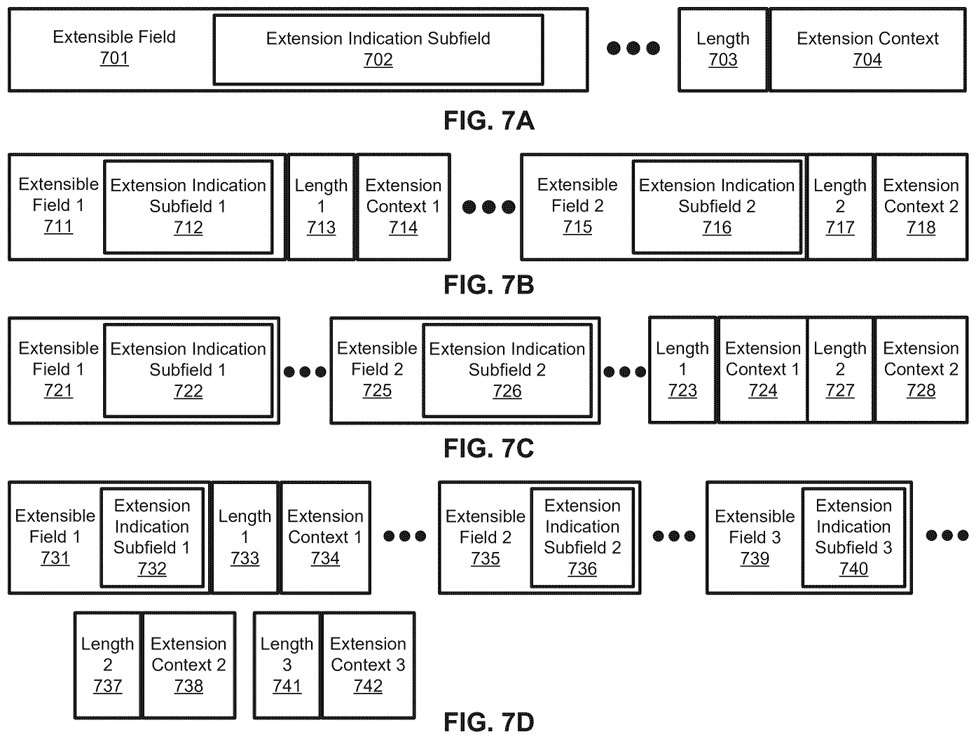

FIGS. 7A-6D are diagrams illustrating various frame formats for communicating one or more extension indications, according to various embodiments.

Referring to FIG. 7A, a frame, e.g., an 802.11 frame, may comprise an extensible field or subfield 701. The 802.11 frame may comprise an extension indication subfield 702. The extension indication subfield 702 may be contained within the extensible field or subfield 701. The extension indication subfield 702 may be configured to indicate the presence of a length field or subfield 703 and an extension context field or subfield 704. Additional fields or subfields may be located between the extension indication subfield 702 and the length field or subfield 703.

Referring to FIG. 7B, a first extension indication subfield 712 may be located within a first extensible field 711. The first extension indication subfield 712 may be followed by a first length field or subfield 713. The first length field or subfield 713 may be followed by a first extension context field or subfield 714. A second extension indication subfield 716 may be located within a second extensible field 715. The second extension indication subfield 716 may be followed by a second length field or subfield 717. The second length field or subfield 717 may be followed by a second extension context field or subfield 718. Additional fields or subfields may be located between the first extension context field or subfield 714 and the second extensible field 715.

Referring to FIG. 7C, a first extension indication subfield 722 may be located within a first extensible field 721. A second extension indication subfield 726 may be located within a second extensible field 725. Additional fields or subfields may be located between the first extensible field 721 and the second extensible field 725. Additional fields or subfields may be located between the second extension indication subfield 726 and a first length field or subfield 723. The first length field or subfield 723 may be followed by a first extension context field or subfield 724. The first extension context field or subfield 724 may be followed by a second length field or subfield 727. The second length field or subfield 727 may be followed by a second extension context field or subfield 728.

Referring to FIG. 7D, a first extension indication subfield 732 may be located within a first extensible field 731. The first extension indication subfield 732 may be followed by a first length field or subfield 733. The first length field or subfield 733 may be followed by a first extension context field or subfield 734. Additional fields or subfields may be located between the first extension context field or subfield 734 and a second extensible field 735. A second extension indication subfield 736 may be located within the second extensible field 735. Additional fields or subfields may be located between the second extensible field 735 and a third extensible field 739. A third extension indication subfield 740 may be located within the third extensible field 739. Additional fields or subfields may be located between the third extension indication subfield 740 and a second length field or subfield 737. The second length field or subfield 737 may be followed by a second extension context field or subfield 738. The second extension context field or subfield 738 may be followed by a third length field or subfield 741. The third length field or subfield 741 may be followed by a third extension context field or subfield 742.

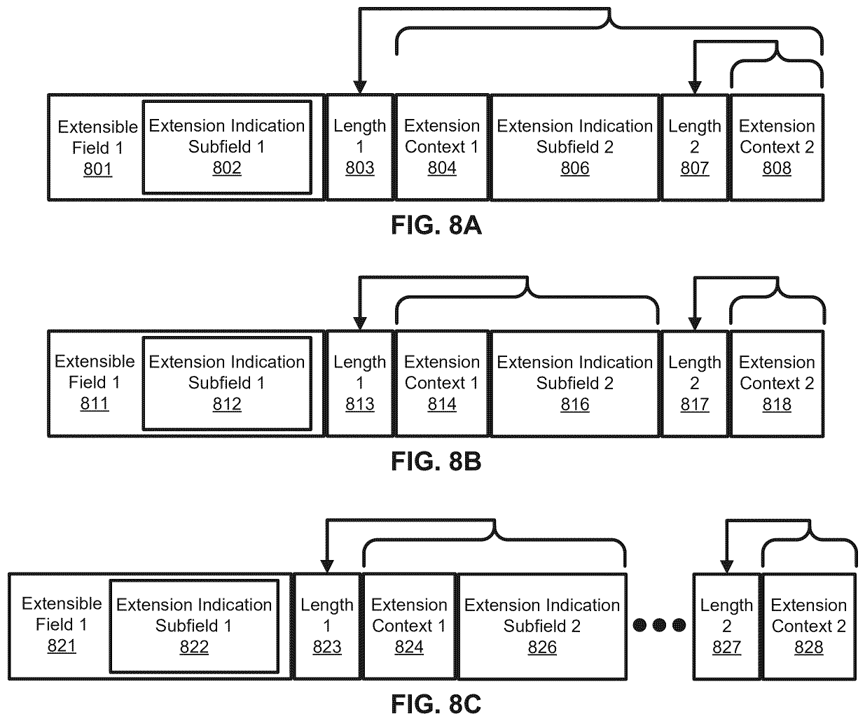

FIGS. 8A-7C are diagrams illustrating various frame formats for communicating multiple extension indications, according to various embodiments.

Referring to FIG. 8A, a first extension indication subfield 802 may be located within a first extensible field 801. The first extension indication subfield 802 may be followed by a first length field or subfield 803. The first length field or subfield 803 may be followed by a first extension context field or subfield 804. The first extension context field or subfield 804 may be followed by a second extension indication subfield 806. The second extension indication subfield 806 may be followed by a second length field or subfield 807. The second length field or subfield 807 may be followed by a second extension context field or subfield 808. The first length field or subfield 803 may be configured to indicate the overall length of the combination of the first extension context field or subfield 804, the second extension indication subfield 806, the second length field or subfield 807, and the second extension context field or subfield 808. The second length field or subfield 807 may be configured to indicate the length of the second extension context field or subfield 808.

Referring to FIG. 8B, a first extension indication subfield 812 may be located within a first extensible field 811. The first extension indication subfield 812 may be followed by a first length field or subfield 813. The first length field or subfield 813 may be followed by a first extension context field or subfield 814. The first extension context field or subfield 814 may be followed by a second extension indication subfield 816. The second extension indication subfield 816 may be followed by a second length field or subfield 817. The second length field or subfield 817 may be followed by a second extension context field or subfield 818. The first length field or subfield 813 may be configured to indicate the overall length of the combination of the first extension context field or subfield 814, and the second extension indication subfield 816. The second length field or subfield 817 may be configured to indicate the length of the second extension context field or subfield 818.

Referring to FIG. 8C, a first extension indication subfield 822 may be located within a first extensible field 821. The first extension indication subfield 822 may be followed by a first length field or subfield 823. The first length field or subfield 823 may be followed by a first extension context field or subfield 824. The first extension context field or subfield 824 may be followed by a second extension indication subfield 826. Additional fields or subfields may be located between the second extension indication subfield 826 and a second length field or subfield 827. The second length field or subfield 827 may be followed by a second extension context field or subfield 828. The first length field or subfield 823 may be configured to indicate the overall length of the combination of the first extension context field or subfield 824, and the second extension indication subfield 826. The second length field or subfield 827 may be configured to indicate the length of the second extension context field or subfield 828.

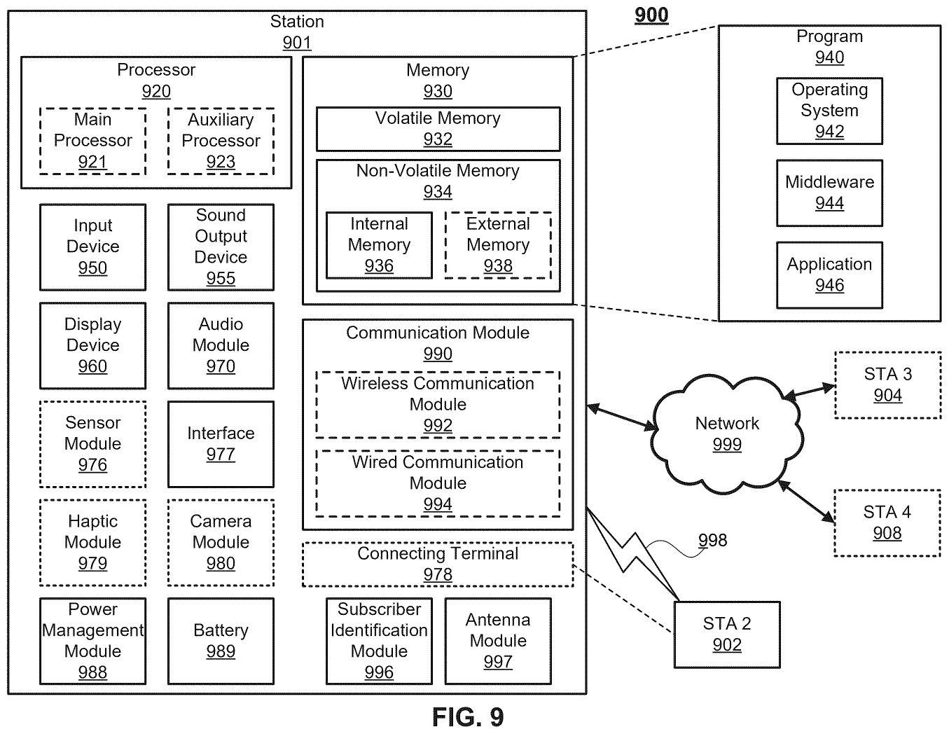

FIG. 9 is a block diagram of a STA in a network environment 900, according to an embodiment.

Referring to FIG. 9, a STA 901 in a network environment 900 may communicate with a second STA 902 via a first network 998 (e.g., a short-range wireless communication network), or a third STA 904 or a fourth STA 908 via a second network 999 (e.g., a long-range wireless communication network). STA 901 may communicate with STA 904 or STA 908. STA 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 997. In one embodiment, at least one (e.g., the display device 960 or the camera module 980) of the components may be omitted from STA 901, or one or more other components may be added to STA 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of STA 901 coupled with the processor 920 and may perform various data processing or computations.

As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of STA 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of STA 901. The various data may include, for example, software (e.g., the program 940) and input data or output data for a command related thereto. The memory 930 may include the volatile memory 932 or the non-volatile memory 934. Non-volatile memory 934 may include internal memory 936 and/or external memory 938.

The program 940 may be stored in the memory 930 as software, and may include, for example, an operating system (OS) 942, middleware 944, or an application 946.

The input device 950 may receive a command or data to be used by another component (e.g., the processor 920) of STA 901, from the outside (e.g., a user) of STA 901. The input device 950 may include, for example, a microphone, a mouse, or a keyboard.

The sound output device 955 may output sound signals to the outside of STA 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of STA 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external STA 902 directly (e.g., wired) or wirelessly coupled with STA 901.

The sensor module 976 may detect an operational state (e.g., power or temperature) of STA 901 or an environmental state (e.g., a state of a user) external to STA 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for STA 901 to be coupled with STA 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which STA 901 may be physically connected with STA 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to STA 901. The power management module 988 may be implemented as at least part of, for example, a power management integrated circuit (PMIC).

The battery 989 may supply power to at least one component of STA 901. The battery 989 may include, for example, a primary cell which is not rechargeable, a secondary cell which is rechargeable, or a fuel cell.

The communication module 990 may support establishing a direct (e.g., wired) communication channel or a wireless communication channel between STA 901 and STA 902, STA 904, or STA 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with an external STA via the first network 998 (e.g., a short-range communication network, such as BLUETOOTH™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate STA 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., an external STA) of STA 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external STA via the selected at least one antenna.

Commands or data may be transmitted or received between STA 901 and STA 904 or STA 908 coupled with the second network 999. Each of the STAs 902 and 904 may be a device of a same type as, or a different type, from STA 901. All or some of operations to be executed at STA 901 may be executed at one or more of the external STAs 902, 904, or 908. For example, if STA 901 should perform a function or a service automatically, or in response to a request from a user or another device, STA 901, instead of, or in addition to, executing the function or the service, may request the one or more external STAs to perform at least part of the function or the service. The one or more external STAs receiving the request may perform the at least part of the function or the service requested, or an additional function or an additional service related to the request and transfer an outcome of the performing to STA 901. STA 901 may provide the outcome, with or without further processing of the outcome, as at least part of a reply to the request. To that end, a cloud computing, distributed computing, or client-server computing technology may be used, for example.

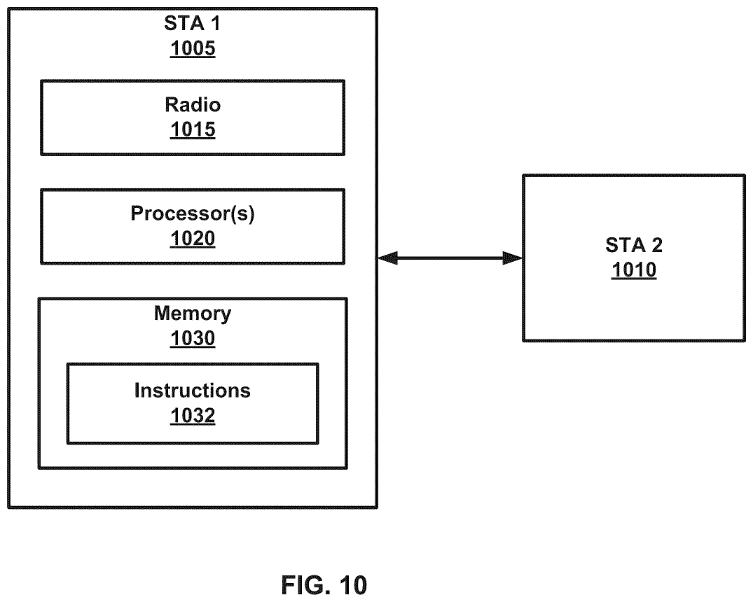

FIG. 10 shows a system including a first STA 1005 and a second STA 1010 in communication with each other, according to an embodiment. The first STA 1005 may include a radio 1015 and a processing circuit (or a means for processing) 1020, which may perform various methods disclosed herein, e.g., the method illustrated in FIG. 2. For example, the processing circuit 1020 may receive, via the radio 1015, transmissions from second STA 1010, and the processing circuit 1020 may transmit, via the radio 1015, signals to the second STA 1010.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a first station (STA), the method comprising:
receiving, from a second STA, a frame including:
an extension indication subfield;
a length field or subfield including length data; and
an extension context field or subfield including extension context data;
determining that the extension indication subfield indicates an extension;
determining a start and end of the extension context field or subfield within the frame based on the length data; and
processing the extension context data.

2. The method of claim 1, wherein the frame is a multicast management frame, and the extension indication subfield is part of an existing or new information element.

3. The method of claim 1, wherein the frame is a multicast control frame, and the extension indication subfield is part of an existing or new field.

4. The method of claim 1, wherein the frame is a multicast data frame, and the extension indication subfield is part of a control subfield using at least one reserved control identifier (ID) value.

5. The method of claim 1, wherein the extension indication subfield is located at the end of an extensible field.

6. The method of claim 1, wherein the extension indication subfield is located in between the beginning of an extensible field and the end of the extensible field.

7. The method of claim 1, wherein the extension indication subfield is located within an extensible field, and the length field or subfield is located immediately following the extension indication subfield.

8. The method of claim 1, wherein the extension indication subfield is located within an extensible field, and at least one additional field is located between the length field or subfield and the extension indication subfield.

9. The method of claim 1, wherein the extension indication subfield is located within an extensible field, the length field or subfield is located immediately following the extension indication subfield, and the extension context field or subfield is located immediately following the length field or subfield.

10. The method of claim 1, wherein the extension indication subfield is located within an extensible field, at least one additional field is located between the length field or subfield and the extension indication subfield, and the extension context field or subfield is located immediately following the length field or subfield.

11. A method performed by a station (STA), the method comprising:
generating an extension indication subfield for a frame, the extension indication subfield indicating an extension;
generating an extension context field or subfield including extension context data;
generating a length field or subfield indicating a length of the extension context field or subfield;
appending the extension indication subfield, the extension context field or subfield, and the length field or subfield to the frame; and
transmitting the frame to at least one other STA.

12. The method of claim 11, wherein the frame is a multicast management frame, and the extension indication subfield is part of an existing or new information element.

13. The method of claim 11, wherein the frame is a multicast control frame, and the extension indication subfield is part of an existing or new field.

14. The method of claim 11, wherein the frame is a multicast data frame, and the extension indication subfield is part of a control subfield using at least one reserved control identifier (ID) value.

15. The method of claim 11, wherein the extension indication subfield is located at the end of an extensible field.

16. The method of claim 11, wherein the extension indication subfield is located in between the beginning of an extensible field and the end of the extensible field.

17. The method of claim 11, wherein the extension indication subfield is located within an extensible field, and the length field or subfield is located immediately following the extension indication subfield.

18. The method of claim 11, wherein the extension indication subfield is located within an extensible field, and at least one additional field is located between the length field or subfield and the extension indication subfield.

19. The method of claim 11, wherein the extension indication subfield is located within an extensible field, the length field or subfield is located immediately following the extension indication subfield, and the extension context field or subfield is located immediately following the length field or subfield.

20. The method of claim 11, wherein the extension indication subfield is located within an extensible field, at least one additional field is located between the length field or subfield and the extension indication subfield, and the extension context field or subfield is located immediately following the length field or subfield.
